(19) United States
(12) Patent Application Publication
(10) Pub. No.: US 2006/0247941 A1
(43) Pub. Date: Nov. 2, 2006

(54) Systems and methods for managing line card capacity

(76) Inventors: Russell Bruce Bellford, New Berlin, WI (US); Orestis Manthoulis, Sausalito, CA (US)

Correspondence Address: MATTHEW E. BURR;LAKE AUSTIN MARINA, 2219 WESTLAKE DR, STE 200, AUSTIN, TX, 78746, US

(21) Appl. No.: 11/118,067

(22) Filed: Apr. 29, 2005

(51) Int. Cl. G06Q 99/00

(52) U.S. Cl. 705/1; 705/28

(57) ABSTRACT

A coordinated, or “joint-replenishment,” system to manage the plug-in circuit card capacity in Remote Terminals or any remote location is advantageous for managing ongoing telecommunications growth, Methods and systems facilitate decisions about when to send a technician to an RT to add ADSL line cards, how many, and to which channel banks serving which Distribution Areas. The system is deemed “coordinated” because the inventory position of ADSL ready cable-pairs between the RT and each DA's cross box served by the RT is considered when making the decision of whether or not to dispatch a technician to the RT for the purpose of adding capacity. The control parameters are calculated, updated, and maintained as part of the system at the DA level.

### FIELD OF THE INVENTION

The present invention relates to high-speed internet service such as Digital Subscriber Lines, and in particular to methods and systems to manage the capacity of line cards in remote terminals.

### BACKGROUND OF THE INVENTION

To provision Digital Subscriber Line (DSL) capability to a neighborhood, multiple Distribution Areas (DAs) are served from a single Remote Terminal (RT). Each DA's DSL demand and DSL-energized cable pair capacity is independent from the other DAs served by the same RT. DSL capacity for the DA is augmented by dispatching a technician to the RT to add DSL line cards to the appropriate DSL capable channel bank. Useful background on Remote Terminals is provided in U.S. Pat. No. 6,480,487 B1, issued Nov. 12, 2002 to Wegleitner, the disclosure of which is incorporated herein by reference in its entirety.

The line card is an electronic printed circuit board in an access network element of a telecommunication network. The function, known as the line terminator function, of the electronic circuits on the card is to interface the telecommunication lines (copper twisted pairs or optical fibers) coming from the subscribers and the rest of the access network element.

The line card terminates a line supporting a voice POTS, ISDN, or a DSL service. Some line cards are capable of terminating more than one type of service.

Since an access network element is, most of the time, intended to interface many users (typically a few thousand) it is desirable to have the largest possible number of line terminations per card. It is common to have many line cards in the same network element.

The cost for dispatching a technician to the RT is large (estimated at $250 per truck roll), but there is no additional setup cost for augmenting the DSL capacity for multiple DAs on a single dispatch or truck roll and the inventory holding cost of unused DSL capacity is large (varies by technology type).

Managing capacity of Asymmetric Digital Subscriber Line (ADSL) line cards in RTs is a complex problem, because it forces a provider to balance two competing costs, each needing to be managed at a different level of aggregation: (1) Truck roll costs are managed at the RT level, and (2) inventory holding costs (or similarly stated, spare capacity costs) are managed at the DA level.

### BRIEF DESCRIPTION OF THE DRAWINGS

The present invention is further described in the detailed description that follows, by reference to the noted drawings, by way of non-limiting examples of embodiments of the present invention, in which reference numerals represent the same parts throughout the several views of the drawings, and in which:

FIG. 1 is a block diagram schematic drawing of a typical Remote Terminal-Distribution Area relationship.

FIG. 2 is a graph plotting Annual Inventory Costs (vertical axis) against Growth (horizontal) for Truck Roll Costs, Holding Costs, and Total Inventory Costs.

FIG. 3 is a series of graphs illustrating a Distribution Area profile of a specific embodiment of the present invention.

FIG. 4 is schematic flow chart of a line card capacity management process of one embodiment of the present invention.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with frequent reference to Asymmetric Digital Subscriber Line (ADSL) line cards in RTs. It is understood, however, that ADSL is merely an example of a specific embodiment of the present invention, which is directed broadly to line card capacity management within the scope of the invention. The terminology, examples, drawings and embodiments, therefore, are not intended to limit the scope of the invention.

Currently, the decision of when and how much ADSL line card capacity to add to an RT is made by local engineers and planners. The timing decisions, that is, the decisions for when to augment line card capacity in a remote terminal, are based primarily on ADSL line card utilization as measured in Web Based Capacity Management (WBCM). Sizing decisions are based on a desire to augment capacity in the RT at roughly 12 month increments.

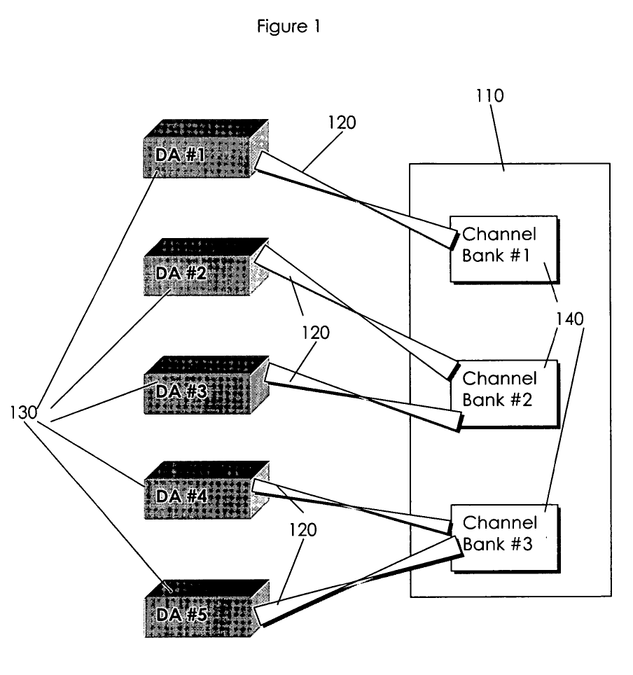

FIG. 1 is a block diagram schematic drawing of a typical Remote Terminal-Distribution Area relationship. Multiple Distribution Areas (DAs) are served from a single Remote Terminal (RT) 110. DSL demand for each DA 130 and the capacity of each DSL-energized cable pair 120 is independent from the other DAs served by the same RT 110. DSL capacity for a DA 130 is augmented by dispatching a technician to RT 110 to add DSL line cards to the appropriate DSL capable channel bank 140.

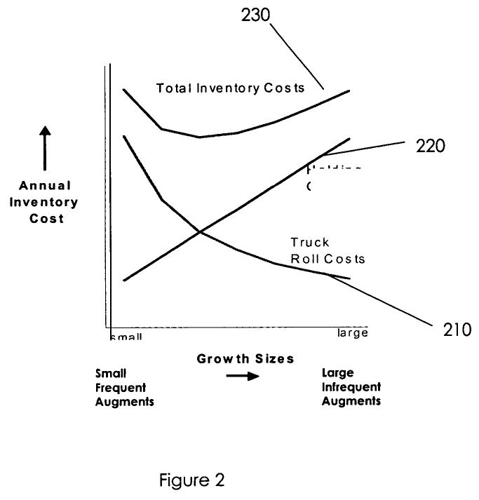

FIG. 2 is a graph plotting Annual Inventory Costs (vertical axis) against Growth (horizontal) for Truck Roll Costs, Holding Costs, and Total Inventory Costs. Truck Roll Costs 210, the cost of dispatching a technician to the RT, is large, estimated at $250 per truck roll. There is, however, no additional setup cost for augmenting the DSL capacity for multiple DAs on a single dispatch or truck roll. The inventory holding cost 220 of unused DSL capacity is large and varies by the type of technology. Total Inventory Costs 230 is the sum of costs 210 and 220. As is evident from FIG. 2, Total Inventory Costs 230 may be minimized by timing capacity augmentation to occur when the curves 210 and 220 intersect.

Accordingly, the present invention introduces a coordinated, or “joint-replenishment,” system to manage the plug-in circuit card capacity in Remote Terminals or any remote location.

The present invention is advantageous for managing ongoing growth. It provides, for example, means for deciding when to send a technician to an RT to add ADSL line cards, how many, and to which channel banks serving which Distribution Areas. The system of the invention is deemed “coordinated” because the inventory position of ADSL ready cable-pairs between the RT and each DA's cross box served by the RT is considered when making the decision of whether or not to dispatch a technician to the RT for the purpose of adding capacity. The control parameters are calculated, updated, and maintained as part of the WBCM system at the DA level.

A profile is established to manage each DA's ADSL line card capacity. This is done to account for the individual demand rate and demand variability of each DA. The profile consists of three parameters: (1) a must-order point (order level), (2) a can-order point (discretionary order level), and (3) an up-to level (no-order level).

Whenever the spare capacity of a DA falls below its must-order point, a replenishment order is triggered that raises the item's spare capacity to its up-to level. Additionally, any other DA with its spare capacity at or below its can-order point is included in the replenishment. If a second or more DA is included, a quantity is ordered to raise its inventory position to its up-to level.

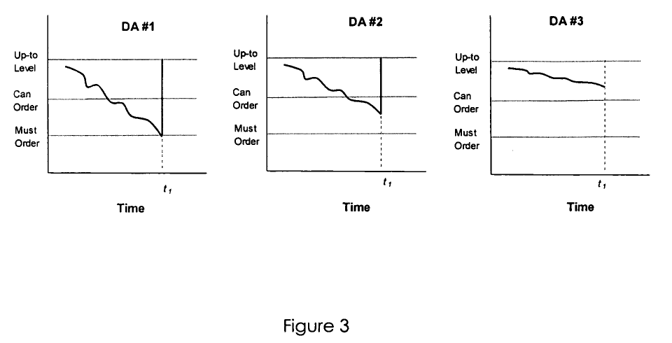

A can-order point allows a DAₙ₊₁, whose spare capacity is low enough to be included in the order triggered by DAₙ, thus eliminating an extra truck roll that would likely occur in the near future when Daₙ₊₁ reaches its must-order point. On the other hand, inclusion of DAₙ₊₁ in the order is not worthwhile if its spare capacity is sufficiently high above its can-order point. The behavior of this type of system is shown in FIG. 3.

FIG. 3 is a series of graphs illustrating a Distribution Area profile of a specific embodiment of the present invention. FIG. 3 shows the spare ADSL ports in an RT with three DAs. At time, t1, DA #1 reaches its must-order point and a replenishment order is automatically generated. At that same time, the system looks at the spare capacity of DA #2 and DA #3 to determine if they should be included in the replenishment. For example, DA #2 is included in the replenishment because its spare capacity is below the can-order point. DA #3, however, is not included, because it has spare capacity in excess of the can-order point. Profile management, ordering and coordination with truck rolls can be accomplished automatically with a suitably programmed computer, for example.

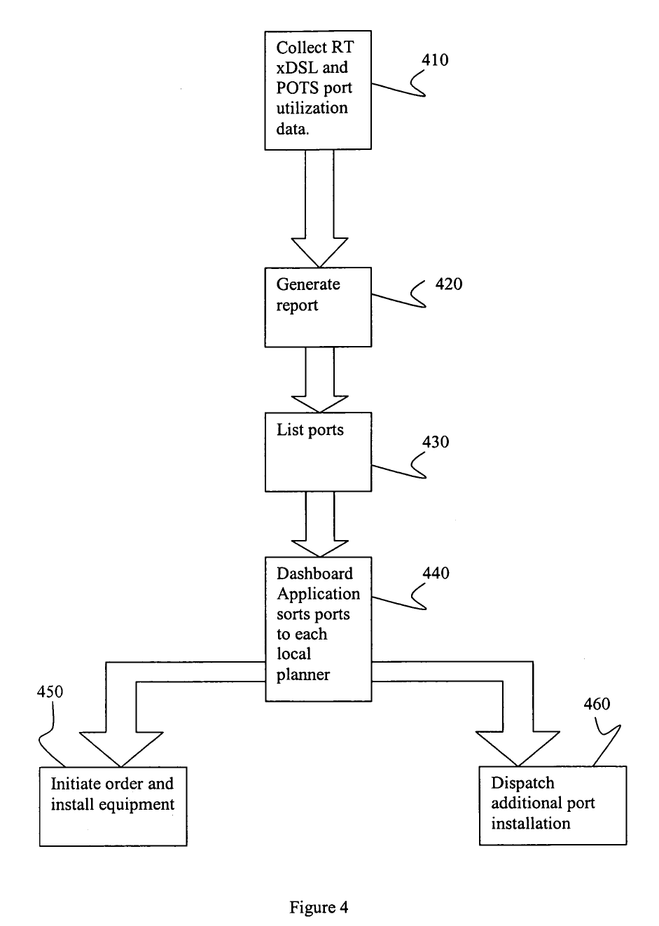

FIG. 4 is schematic flow chart of a line card capacity management process of one embodiment of the present invention. An exemplary process is described of notifying the individual area planners that a new order and dispatch must occur.

Step 1 (410): A Web based capacity management tool collects the Remote Terminal's xDSL and POTS port utilization data at the DA level, once per week.

Step 2 (420): A report is generated by the tool to identify the level of cable pair exhausts and POTs and xDSL card exhaust at the DA level.

Step 3 (430): A list of RTs is identified with the number of ports that need to be added each week. The list may be compiled with the aid of an algorithm such as that described herein above.

Step 4 (440): The output of step 2 and 3 is provided to a separate application (such as a browser dashboard, for example), that sorts the information per local planner, as each planner is responsible for a group of RTs.

Step 5a (450): If step 2 has identified a cable pair exhaust, the dashboard notifies the local planner that a new copper conduit or that new equipment (for example, a channel bank assembly or new box) needs to be installed. After review of the information, the local planner initiates that needed order. With the order in hand, the conduit or equipment is installed by the outside plan technician.

Step 5b (460): If no cable pair exhaust occurs for that DA/RT, a xDSL and POTS port order for that RT is pre-populated from the application, with information that identifies how many and what type of ports must be added at each DA served by that RT. The local planner approves the port order, and an installation dispatch occurs for a technician to install the needed ports in each of the RTs.

Evaluation of the process with WBCM data from over 100 DAs in the Midwest during the time period June 2003 through June 2004 has demonstrated a significant cost savings potential. Existing capacity management methods do not consider the cost structure of the problem. The present invention advantageously explicitly quantifies the cost of truck rolls and the cost of holding spare capacity.

Capacity management decisions made under the prior art methods are based on utilization thresholds for timing growth augments and meeting time-supply targets for sizing growth augments. In a system of the present invention, in contrast, all control parameters (discretionary order level, order level, and no-order level) are formulated to minimize overall cost while meeting service level objectives.

A further advantage of the present invention is that, unlike prior methods, it considers and quantifies the variability of lead-time demand when decisions are made about when to add capacity. Short (e.g., one week) lead times allow spare capacity in the DA to be kept low with relatively little risk. The present method includes lead time as a management controlled variable.

The present process includes an Economic Order Quantity (EOQ), which is based upon a recommendation, derived from the profile, regarding how much capacity to add. Prior processes, in contrast, base quantities on meeting time-supply targets for sizing growth augments (i.e., aim to add 12 months worth of capacity) that are established without regard to the cost structure of the problem.

Savings in the number of truck rolls under a system of the present invention result from consideration of the inventory position in all of the DAs served by a single RT, rather than managing each DA's capacity independently. The process is formulated to consider the entire problem to achieve cost minimization.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

I claim:

1. A system for managing line card capacity in a Digital Subscriber Line Remote Terminal serving at least one Distribution Area, the system comprising:
a profile of one or more first Distribution Area, the profile further comprising an order inventory level, a discretionary order inventory level, and a no-order inventory level, wherein the profile tracks available line card slots in the first Distribution Area over time;
means for automatically determining the profile of one or more second Distribution Areas;
means for automatically ordering one or more line cards for the Distribution Areas served by the Remote Terminal on the basis of each Distribution Area's profile at a selected time; and
means for coordinating the installation of ordered line cards with a truck roll to the Remote Terminal.

2. The system of claim 1, further comprising a computer programmed to accomplish at least one element of the system.

3. The system of claim 1, wherein the system optimizes total inventory costs.

4. The system of claim 1, wherein the cost of trucks rolls and the cost of holding capacity are quantified.

5. The system of claim 1, wherein the system optimizes line card capacity in the Remote Terminal.

6. The system of claim 1, further comprising an EOQ recommendation based on the profile of at least one Distribution Area.

7. A method for managing line card capacity in a Digital Subscriber Line Remote Terminal serving at least one Distribution Area, the method comprising:
profiling one or more first Distribution Area, the profile further comprising an order inventory level, a discretionary order inventory level, and a no-order inventory level, wherein the profile tracks available line card slots in the first Distribution Area over time;
automatically determining the profile of one or more second Distribution Areas;
automatically ordering one or more line cards for the Distribution Areas served by the Remote Terminal on the basis of each Distribution Area's profile at a selected time; and
coordinating the installation of ordered line cards with a truck roll to the Remote Terminal.

8. The method of claim 7, further comprising providing a computer programmed to perform at least one element of the method.

9. The method of claim 7, wherein the method optimizes total inventory costs.

10. The method of claim 7, wherein the cost of trucks rolls and the cost of holding capacity are quantified.

11. The method of claim 7, wherein the method optimizes line card capacity in the Remote Terminal.

12. The method of claim 7, further comprising recommending an EOQ based on the profile of at least one Distribution Area.

13. A method for automatically notifying an area planner to initiate a new order and dispatch, the method comprising:
collecting xDSL and POTS port utilization data from a Remote Terminal;
identifying the level of cable pair exhausts and POTs and xDSL card exhausts.
listing the number of ports that need to be added to the Remote Terminal;
sorting the information to the planner responsible for the Remote Terminal;
in the case of a cable pair exhaust, automatically notifying the planner that a new copper conduit or that new equipment needs to be installed; and
in the case of no cable pair exhaust, automatically ordering the xDSL and POTS ports for dispatch and installation at the Remote Terminal.

14. A computer programmed to perform programmed functions for managing line card capacity in a Digital Subscriber Line Remote Terminal serving at least one Distribution Area, the functions comprising:
profiling one or more first Distribution Area, the profile further comprising an order inventory level, a discretionary order inventory level, and a no-order inventory level, wherein the profile tracks available line card slots in the first Distribution Area over time;
automatically determining the profile of one or more second Distribution Areas;
automatically ordering one or more line cards for the Distribution Areas served by the Remote Terminal on the basis of each Distribution Area's profile at a selected time; and
coordinating the installation of ordered line cards with a truck roll to the Remote Terminal.
